(19) United States
(12) Patent Application Publication
(10) Pub. No.: US 2009/0259674 A1
(43) Pub. Date: Oct. 15, 2009

(54) AGGREGATING INFORMATION SOURCES TO DYNAMICALLY UPDATE A CALENDAR AND TO NOTIFY USERS OF CHANGES

(75) Inventors: DAVID L. GRIFFIN, RALEIGH, NC (US); HAROLD STEPHEN HAYDEN, NEW HILL, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/103,123

(22) Filed: Apr. 15, 2008

(51) Int. Cl. G06F 17/30

(52) U.S. Cl. 707/101; 707/E17.006

(57) ABSTRACT

Received information from a set of information sources can be processed. The processing can convert the received information into a standardized form. An effect that the converted information has upon a set of scheduled events of a calendaring application can be determined based upon a set of configurable rules. One or more programmatic action relating to the scheduled events can be taken based upon the determined effect. Programmatic actions can include notifying a user associated with the effected scheduled event and automatically changing an attribute associated with the scheduled event within a database used by the calendaring application.

### BACKGROUND OF THE INVENTION

The present invention relates to the field of information aggregation, more particularly, to aggregating information sources to dynamically update a calendar and to notify users of changes.

It is common for a business to setup a computer server to host a suite of software to improve office management and communication. These software applications often include a calendar, which can allow for the management of the schedules of the company's employees. Calendaring applications can aid the company in managing meeting times, planned trips, company functions, and the like. When information is fed to these calendaring applications, shared across a business enterprise, and provided in an updated form to planning devices (e.g., mobile phones, personal data assistants, printed calendars/schedules), these calendaring applications can become a centralized coordination resource for business activity. That is, calendaring applications and information contained therein can drive critical functions of a business.

Like any automated system, a value of calendaring application directly correlates to an accuracy and timeliness of the underlying information, which it manages. Information relevant from a calendaring application can be maintained in multiple diverse systems, each capable of providing an information stream or feed to the calendaring application. Information feeds can be streams of data served to users that contain information regarding a subject or subjects. These information feeds can be provided in any format, but not limited to, FM radio, web services, RSS (Rich Site Summary), and the like. Such information sources can include important updates for certain users. For example, an information source can include updates of flight information for an airline or airlines.

A sheer diversity of information feeds creates handling problems, which has historically required manual user interactions. That is, humans often receive an information feed, interpret it, determine relevant effects of this information upon calendar entries, and manually make suitable updates. This process can be time consuming and ad-hoc. Additionally, humans attempting to interpret vast quantities of available information are prone to cognitive overload, which usually results in their placing inflated emphasize on a small subset of information sources and effectively excluding others.

Conventional systems have not resulted in an efficient, maintainable automated solution for aggregating diverse information for purposes of calendaring automation. One reason is that both calendaring applications and information sources are subject to change, where these changes affect fundamental characteristics essential to information feeds. Therefore, even if a user successfully maps key information sources to a calendaring application at a point in time, these mappings quickly become outdated. An expense maintaining these links using conventionally created software tools generally outweighs benefits gained through the linked. For example, it can be easier, as accurate, and more cost efficient to have a human agent (e.g., a secretary) shift through data from multiple sources than to hire a computer specialist to constantly maintain/correct links between a calendaring application and multiple information feeds.

### BRIEF SUMMARY OF THE INVENTION

One aspect of the present invention can include a method, apparatus, computer program product, and system for permitting calendar events to adjust based upon information source data. Received information from a set of information sources can be processed. The processing can convert the received information into a standardized form. An effect that the converted information has upon a set of scheduled events of a calendaring application can be determined based upon a set of configurable rules. One or more programmatic action relating to the scheduled events can be taken based upon the determined effect. Programmatic actions can include notifying a user associated with the effected scheduled event and automatically changing an attribute associated with the scheduled event within a database used by the calendaring application.

### BRIEF DESCRIPTION OF THE SEVERAL VIEWS OF THE DRAWINGS

FIG. 1 is a schematic diagram of a system for aggregating information sources to dynamically update a calendar and notify users of changes in accordance with an embodiment of the inventive arrangements disclosed herein.

FIG. 2 is a diagram of a set of configuration interfaces for aggregating information sources to dynamically update a calendar and notify users of changes in accordance with an embodiment of the inventive arrangements disclosed herein.

FIG. 3 is a flow chart of a method for aggregating information sources to dynamically update a calendar and notify users of changes in accordance with an embodiment of the inventive arrangements disclosed herein.

### DETAILED DESCRIPTION OF THE INVENTION

The present invention can include an aggregator which can gather information from a plurality of information sources to dynamically update a calendar and notify users of changes. Information sources can include, but are in no way limited to, RSS, email, FM radio, and the like. The aggregator can convert these incoming sources into a standard digital format, so all of the incoming sources can be processed and served in the same format. Further the aggregator can utilize extensible modules to convert these incoming sources to the standard digital format, so changes to existing sources can be simply and efficiently made and new sources can be easily added to the system. These information sources can be provided by any source, including, but in no way limited to, airlines, school systems, sports leagues, news providers, private office news, and the like. A conveyance methodology and format used by these information sources can vary substantially as well, from sensor output, to FM signals, to email messages, RSS feeds, and the like.

The aggregator can review the data gathered from the information sources and compare the data to user configurable rules. These rules can specify an action or actions to perform when the data received from the information sources matches certain criteria. For example, if the data received from the information sources includes news of a plane being cancelled, a rule can be set to automatically attempt rescheduling the flight, which can in turn notify any peers who are affected by the schedule change.

The present invention can allow the notification of any number of users. For example, when a schedule change is made and effects a peer's schedule, the effect on the peer's schedule may have an effect on more peers' schedules. The present invention can include a solution to detect these conflicts and send update notifications to all peers. In one embodiment, the processing from information source to notification can occur in a time sensitive manner (such as in real-time or near-real-time) to ensure timely notifications occur.

An update notification can be a user configured solution for contacting the peer regarding the schedule change. An update notification can be a formatted message or communication including the details of the schedule change. The format used can be in accordance with a pre-existing calendar engine which can use the formatted message to automatically update a personal calendar. An update notification can be, but is not limited to, a phone call, email message, OUTLOOK formatted calendar event, LOTUS NOTES CALENDARING formatted calendar event, and the like. In one embodiment, one or more different notification devices and/or notification mechanisms can be utilized selectively depending upon a criticality of a notification. For example, a relatively non-urgent update affecting a calendaring event can update a related record in a calendaring application only; a more urgent update can update the record and send an email notification; and, an even more urgent notification can update the record, send an email notice, and can send a voicemail message to a mobile telephone number.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

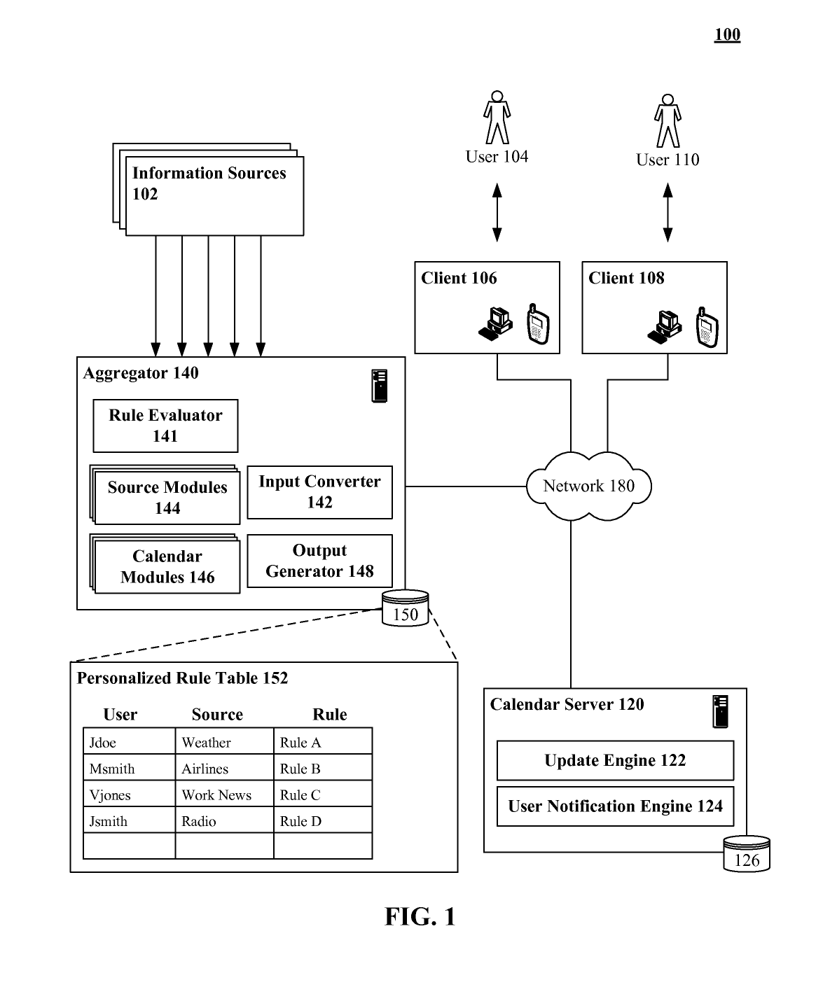

FIG. 1 is a schematic diagram of a system 100 for aggregating information sources to dynamically update a calendar and notify users of changes in accordance with an embodiment of the inventive arrangements disclosed herein. System 100 can include users 104 and 110, which can interact with clients 106 and 108 respectively. Clients 106 and 108 can interact with calendar server 120 and aggregator 140 via network 180. Calendar server 120 can host a network calendar for clients 106 and 108. Calendar server 120 can include update engine 122, user notification engine 124, and data store 126. Using update engine 122, calendar server 120 can receive schedule update requests from aggregator 140. In one embodiment, the entire process from receiving an update from an information source 102 to providing a notification to a user can occur in real-time, near-real time, or just in a time sensitive manner appropriate for a given situation. For example, a notification regarding a change of an airlines flight scheduled in two hours can be processed through system 100 more rapidly than an information update regarding a meeting two months away.

Aggregator 140 can be a computing device which can include rule evaluator 141, source modules 144, input converter 142, calendar modules 146, output generator 148, and data store 150. Aggregator 140 can use source modules 144 to receive data from information sources 102. Source modules 144 can include a plurality of modules. It is contemplated that aggregator 140 can include a source module 144 to correspond to each information source 102. Source modules 144 can provide the necessary functionality to receive data from information sources 102. Input converter 142 can include the necessary functionality to convert the raw input received from information sources 102 through source modules 144 into a standard digital format. Rule evaluator 141 can be an engine in which can evaluate scheduling rules stored on data store 150. These rules can include a criteria in which data received by information sources 102 can meet. When this criteria is matched, the rule can be executed by rule evaluator 141. The rule can contain actions to be performed, such as rescheduling a cancelled appointment and notifying peers of the schedule change. Rule evaluator 141 can use output generator 148 to generate the necessary output to execute the actions contained in the rule. The output generated from output generator 148 can be used in conjunction with calendar modules 146 to interact with update engine 122 and update schedules stored on calendar server 120.

Information sources 102 can be a plurality of public and/or private data sources. These sources can include, but are not limited to, FM radio, news providers, RSS (Rich Site Summary) feeds, web services, and the like. These sources 102 can provide information regarding a multitude of subjects including, but not limited to, weather, traffic jams, airline or train information, school notifications, and the like.

Aggregator 140 can receive input from information sources 102, convert it to a standard format using input converter 142, and process the input using rule evaluator 141. When processing input, rule evaluator 141 can use output generator 148 to provide formatted output for calendar modules 146. Calendar modules 146 can convey the output to update engine 122 of calendar server 120. Aggregator 140 can be any computing device, including, but not limited to a server computer, a workstation, a laptop computer, or the like.

Source modules 144 can be machine-readable instruction code that can contain the functionality required to receive input from an information source 102. The source module 144 can include the location and solution in which to receive the data from the source. For example, if the information source is an FM radio, the corresponding source module 144 can include the frequency and band the data is being transmitted in. In another example, if the information source is an RSS feed, the source module 144 can contain the URL (Uniform Resource Locator) to access the information source. It is also contemplated that sources can “push” the data to aggregator 140 (i.e. email, instant messaging) or aggregator 140 can “pull” the data from the information source 102 (i.e. RSS, web services).

Input converter 142 can convert the raw input provided from source modules 144 into a standard usable format. In some embodiments, there can be a plurality of input converter 142 to provide the necessary functionality to support a wider range of information sources. In the example that the information source is an FM radio broadcast, input converter 142 can include an analog to digital converter to convert the FM signal. Input converter 142 can convert each information source into a standard format for processing and/or display.

Rule evaluator 141 can be machine-readable instruction code for evaluating personalized rules stored in data store 150. These personalized rules can be conveyed to aggregator 140 by users 104 and 110 using clients 106 and 108 respectively. Rule evaluator 141 can check for updated information from information sources 102 at a preconfigured interval. If updated information is found, rule evaluator 141 can evaluate rules pertaining to the updated information. When the criteria is met pertaining to the rule, rule evaluator 141 can execute the actions required by the rule. Rule evaluator 141 can use output generator 148 to generate appropriate output and use calendar modules 146 to convey the output.

Output generator 148 can create formatted pertaining to the evaluated rule by rule evaluator 141. Rule evaluator 141 can determine which actions should be taken to execute the evaluated rule. Rule evaluator 141 can generate the schedule change request or requests necessary to be conveyed through calendar modules 146.

Calendar modules 146 can be machine-readable instruction code modules for communicating with different calendar servers, such as calendar server 120. The code contained in calendar modules 146 can describe the acceptable data format and solution for communicating with the servers. It is contemplated that calendar modules 146 can be user configurable to work with any server.

Data store 150 can contain the necessary machine-readable instruction code to facilitate the functionality described herein. In some embodiments, data store 150 can also include a cache of information sources 102. The cache can be used to detect updates to information sources 102. Data store 150 can store the personalized scheduling rules of users such as users 104 and 110. Such rules can be illustrated in personalized rule table 152. Personalized rule table 152 shows fields user, source, and rule. User can be a field used to store the user in which owns the rule. Source can be a field used to store the information source in which the rule pertains to. Rule can be a field in which can be used to store the criteria for the information source to meet to trigger the execution of the rule.

Calendar server 120 can be a computing device in which can serve a public or private calendar for users. Calendar server 120 can run a software application to produce this functionality. Calendar server 120 can include update engine 122, which can allow the interaction between calendar server 120 and aggregator 140. Calendar server 120 can also include user notification engine 124, which can be used when a calendar update requires the notification of a user. Calendar server 120 can also include data store 126, which can be used to store the necessary data to serve the calendar to users such as users 104 and 110.

Update engine 122 can be machine-readable instruction code in which can implement, in one embodiment, a SOA (Service Oriented Architecture) solution, such as using an XML implementation or a Web service to communicate. Update engine 122 is not limited to any particularly implementation technology, however, and can also be implemented as JAVA-based, C based, etc. enhancement to calendaring functionality. Update engine 122 can enable calendar server 120 to communicate with aggregator 140.

User notification engine 124 can be machine-readable instruction code for the notification of peers of schedule updates. For example, if user 104 conveyed a rule for their calendar on calendar server 120 using client 106, when the rule is executed it can require the notification of another user. In this example, user 110 can be affected by the schedule change and therefore notified. User 110 can be notified in a user configurable manner. The protocol, as well as the format in which to notify user 110 can be configured. For example, user 110 can be contacted via email. In some cases, the computing device 108 user 110 uses can support multiple email formats, including, but not limited to HTML, text, and OUTLOOK calendar format. The user notification engine 124 can utilize a variety of notification means, such as email, phone, fax, IM, text messaging, and the like. In one embodiment, the notification engine 124 can utilize different notification mechanisms depending upon an urgency and/or importance of a notification being sent.

Clients 106 and 108 can be any computing device capable of interacting with calendar server 120 and aggregator 140. Clients 106 and 108 can run software applications to allow the communication with calendar server 120 and aggregator 140. For example, calendar server 120 can run a web-based calendar, and therefore clients 106 and 108 can use a web browser to interface with the web-based calendar. Clients 106 and 108 can also interact with aggregator 140 to add, modify, and/or delete personalized scheduling rules. Clients 106 and 108 can be any computing device, including, but not limited to a desktop computer, laptop computer, mobile phone, PDA (personal data assistant), or the like.

Data stores 126 and 150 can be physically implemented within any type of hardware including, but not limited to, a magnetic disk, an optical disk, a semiconductor memory, a digitally encoded plastic memory, a holographic memory, or any other recording medium. The data stores 126 and 150 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

Network 180 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 180 can include local components and data pathways necessary for communications to be exchanged among computing device components and between integrated device components and peripheral devices. The network 180 can also include network equipment, such as routers, data lines, hubs, and intermediary servers which together form a packet-based network, such as the Internet or an intranet. The network 180 can further include circuit-based communication components and mobile communication components, such as telephony switches, modems, cellular communication towers, and the like. The network 180 can include line based and/or wireless communication pathways.

It should be appreciated that the configuration and specifics of system 100 can be implemented in numerous manners other than those explicitly shown. For instance, in one contemplated embodiment, the functionality of aggregator 140 can be incorporated within the calendaring server 120. In another embodiment, input from one or more information sources 102 can be pre-processed before being conveyed to the aggregator 140. For example, the input converter 142 and source modules 144 can be a pluggable component of the information sources 102 themselves and/or can be performed by a network element communicatively positioned between sources 102 and aggregator 140. In still another embodiment, notification (engine 124) can be configured within the aggregator 140 (or as part of an aggregation and notification service) implemented distinct and independent of any calendaring server 120. These deviations of system 100 are not intended to be exhaustive, but are intended to illustrate that the disclosed inventive elements of system 100 are able to be implemented in numerous implementation specific configurations.

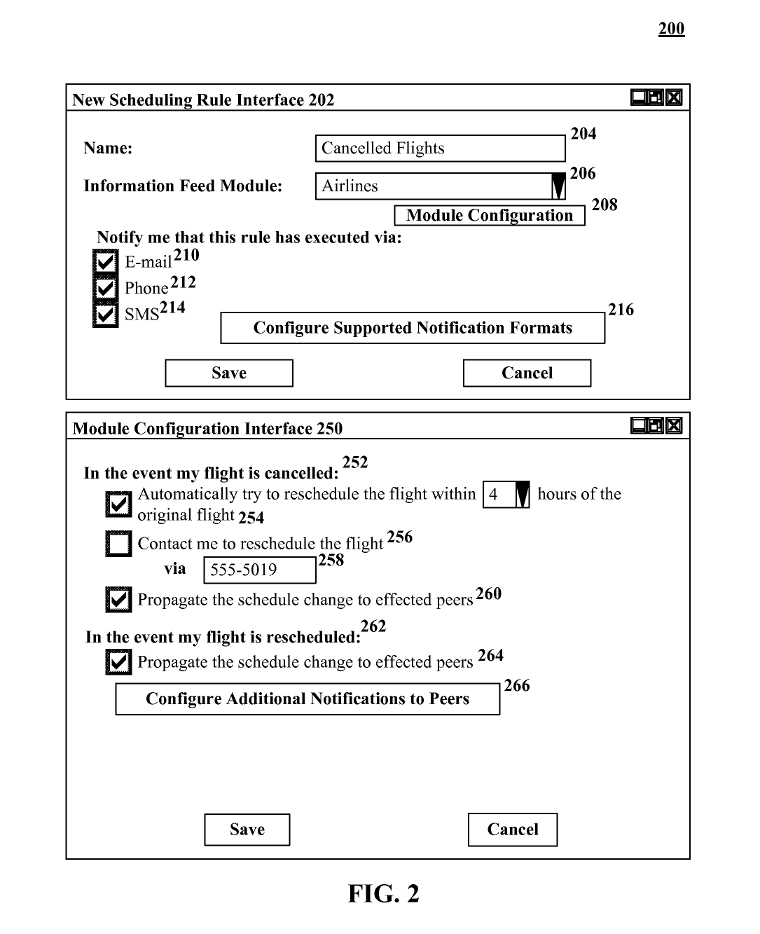

FIG. 2 is a diagram of a set of configuration interfaces for aggregating information sources to dynamically update a calendar and notify users of changes in accordance with an embodiment of the inventive arrangements disclosed herein. FIG. 2 can include new scheduling rule interface 202 and module configuration interface 250. Interfaces 202, 250 can be implemented in context of system 100. These interfaces 202, 250 are for illustrative purposely only and different interface elements, arrangements, and the like are contemplated. For example, although shown as graphical user interfaces (GUI), one or more of the interfaces 202, 250 can be implemented as a voice user interface (VUI), a multi-modal interface, and the like.

New scheduling rule interface 202 can be an interface for customizing a new scheduling rule. Button 208 of interface 202 can be a GUI control to initiate the configuration of individual options for the chosen module in option 206 of interface 202. Option 204 can allow the specification of a name for the scheduling rule. Option 206 can allow the specification of the information feed module to be used. An information feed module can be in the context of source modules 144 of system 100. There can be an information feed module for each possible information feed. Button 208 can be associated with option 206 and initiate interface 250. Options 210-214 can allow the specification of notification mediums. These mediums can be employed for notification when the rule executes. Option 210 can allow notification via email. Option 212 can allow notification via phone. Option 214 can allow notification via SMS (Simple Messaging System). Button 216 can be associated with options 210-214 and allow the further configuration of supported notification formats. For example, a user may support individual formatted email notifications to interface with another software application.

Module configuration interface 250 can be an interface for configuring options specific to the module chosen in option 206 of interface 202 (Airlines). Option 252 can denote that options 254-260 will pertain to when a flight is cancelled. Option 254 can allow the automatic attempt to reschedule the flight within a configurable duration of the original flight. Option 256 can allow the user to specify they would like to be contacted by a representative to reschedule the flight. Option 258 can allow the specification of how to contact the user to reschedule their flight. Option 258 shows a phone number, but can be any communication medium. Option 260 can enable the propagation of the schedule change to any peers that have been affected by the change. A means of notifying the effected peers of the change can be user configurable (not shown). Option 262 can denote that options 264 and 266 pertain to the event when the user's flight has been rescheduled. Option 264 can enable the propagation of the schedule change to any peers that have been affected by the change. Option 266 can allow the configuration of additional peers to be notified of a rescheduled flight.

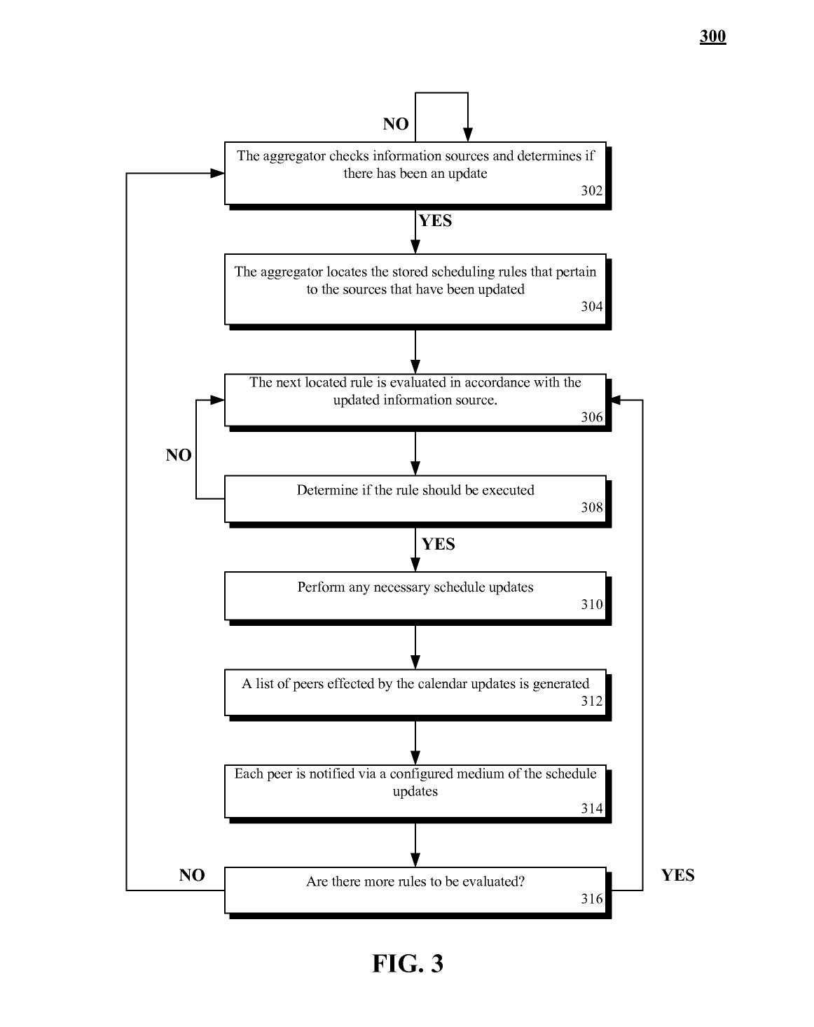

FIG. 3 is a flow chart of a method 300 for aggregating information sources to dynamically update a calendar and notify users of changes in accordance with an embodiment of the inventive arrangements disclosed herein. Method 300 can be performed in context of a system 100.

Method 300 can begin in step 302, where the aggregator can check information sources and determine if there has been an update. If in step 302, the information sources have not been updated since the last check, method 300 can loop back to step 302. This loop can pause for any time interval. If in step 302, there has been an update to at least one information source, method 300 can continue to step 304, where the aggregator can locate the stored scheduling rules that pertain to the source or sources that have been updated. In step 306, the next located rule can be evaluated in accordance with the updated information source. In step 308, the aggregator can determine if the rule should be executed (i.e. the updated information source matches the rules criteria). If in step 308, the rule should not be executed, method 300 can return to step 306, where the next located rule can be evaluated in accordance with the updated information source.

If in step 308, the rule should be executed, method 300 can continue to step 310, where any necessary schedule updates can be performed. For example, if the rule is configured to reschedule a meeting, trip, or event, these schedule changes can be performed. In step 312, a list of peers affected by the calendar updates can be generated. In step 314, each peer can be notified via a configured medium of the schedule updates. In step 316, it can be determined if there are more rules to be evaluated. If in step 316, there are more rules to evaluate, method 300 can return to step 306, where the next located rule can be evaluated in accordance with the updated information source. If in step 316, there are no more rules to evaluate, method 300 can return to step 302, where the aggregator can check information sources and determine if there has been an update.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for permitting calendar events to adjust based upon information source data comprising:
processing received information from a plurality of information sources, said processing converting said received information into a standardized form;
determining an effect of said converted information upon a plurality of scheduled events of a calendaring application based upon a plurality of rules; and
performing at least one programmatic action relating to the at least one scheduled events based upon the determined effect, wherein said at least one programmatic action comprises at least one action selected from a group of actions consisting of constructing and conveying a notification to at least one user associated with an effected scheduled event, and an action of automatically changing an attribute associated with an effected scheduled event within a database used by the calendaring application.

2. The method of claim 1, further comprising:
establishing a plurality of source modules, each source module being associated with an information source;
determining a source module associated with a data source before processing information received from each information source; and
utilizing the determined source module to convert information from the associated source into said standardized form.

3. The method of claim 2, wherein said at least one performed programmatic action comprises the action of automatically changing an attribute associated with an effected scheduled event within the database used by the calendaring application.

4. The method of claim 3, wherein said changed attribute comprises a change from one participation type associated with the scheduled event to another participation type, wherein said participation type comprises physical attendance of the scheduled event, and at least one tele-presence participation mode for the scheduled event.

5. The method of claim 2, wherein said at least one performed programmatic action comprises the action of constructing and conveying a notification to at least one user associated with an effected scheduled event.

6. The method of claim 5, wherein said processing of received information, said determining the effect, and said performing of the at least one programmatic action is performed in real-time or near-real-time.

7. The method of claim 5, wherein said constructing comprises creating synthesized speech content that is said notification, wherein said conveying of the notification comprises dialing a phone number associated with said at least one user and audibly conveying said created synthesized speech when a telephony communication session is initiated related to said dialing.

8. The method of claim 5, wherein said notification is personalized for said at least one user.

9. The method of claim 1, wherein said processing of received information, said determining the effect, and said performing of the at least one programmatic action is performed by an aggregating network element operating independent of the calendaring application, where said aggregating network element is communicatively linked to the calendaring application.

10. The method of claim 9, wherein said aggregating network element is configured to interoperate with a plurality of different commercial-off-the-shelf calendaring applications.

11. The method of claim 9, wherein said processing of received information, said determining the effect, and said performing of the at least one programmatic action are actions performed by a Web service, to which a user of the calendaring application subscribes.

12. The method of claim 1, wherein said plurality of rules are user configurable rules specific to at least one user, wherein said scheduled events to which said plurality of rules are applied are scheduled events associated with said at least one user.

13. The method of claim 12, wherein said user configurable rules specify variable details determining behavior of said performed at least one programmatic action specific to said at least one user.

14. The method of claim 13, wherein said at least one effected scheduled event is associated with a plurality of different users, wherein at least two different user configurable rule sets exist which corresponding to different ones of plurality of different users, wherein said at least two different user configurable rule sets result in a performance of at least two different programmatic actions, each different programmatic action being performed responsive to one of the different user configurable rule sets.

15. The method of claim 1, wherein one of said plurality of information sources comprises a public Web source, and wherein a different one of said plurality of information sources comprises a private Service Oriented Architecture (SOA) source whose access is restricted to authorized entities, wherein another one of said plurality of information sources comprises a digital Frequency Modulation (FM) broadcast, and wherein still another one of said plurality of information sources comprises a digital sensor.

16. The method of claim 1, wherein one of said plurality of information sources comprises a digital sensor; said method further comprising:
said digital sensor detecting an environmental condition of an ambient environment and generating a value for said detected environmental condition;
processing said generated value as an element of said received information, thereby converting the generated value into a standardized form;
comparing a user configured threshold established within one of the plurality of rules against the standardized form of the generated value; and
determining based upon said comparing that conditions of said ambient environment result in a time adjustment of said effected scheduled event, wherein said programmatic action are associated with said time adjustment.

17. The method of claim 1, wherein one of said plurality of information sources comprises a private Service Oriented Architecture (SOA) source whose access is restricted to authorized entities, wherein said plurality of rules are user configurable rules specific to at least one user, wherein said scheduled events to which said plurality of rules are applied are scheduled events associated with said at least one user, said method further comprising:
establishing a data store of entity authorizing information for accessing the Service Oriented Architecture (SOA) source, said entity authorizing information being associated with at least one authorized user;
retrieving from the data store the entity authorizing information when processing said SOA portion of received information from the Service Oriented Architecture source; and
applying said SOA portion when determining the effect and performing the at least one programmatic action based upon said SOA portion only for a subset of users that are associated with the entity authorizing information.

18. A computer program product for permitting calendar events to adjust based upon information source data comprising, a computer usable medium having computer usable program code embodied therewith, the computer usable program code comprising:
a computer usable program code configured to process received information from a plurality of information sources, said processing converting said received information into a standardized form;
a computer usable program code configured to determine an effect of said converted information upon a plurality of scheduled events of a calendaring application based upon a plurality of rules; and
a computer usable program code configured to perform at least one programmatic action relating to the at least one scheduled events based upon the determined effect, wherein said at least one programmatic action comprises at least one action selected from a group of actions consisting of constructing and conveying a notification to at least one user associated with an effected scheduled event and an action of automatically changing an attribute associated with an effected scheduled event within a database used by the calendaring application.

19. A system for permitting calendar events to adjust based upon information source data comprising:
a bus;
a memory connected to the bus, wherein the memory contains a set of instructions; and
a processor connected to the bus, wherein the processor is operable to execute the instructions, wherein said instructions:
process received information from a plurality of information sources, said processing converting said received information into a standardized form;
determine an effect of said converted information upon a plurality of scheduled events of a calendaring application based upon a plurality of rules; and
perform at least one programmatic action relating to the at least one scheduled events based upon the determined effect, wherein said at least one programmatic action comprises at least one action selected from a group of actions consisting of constructing and conveying a notification to at least one user associated with an effected scheduled event and an action of automatically changing an attribute associated with an effected scheduled event within a database used by the calendaring application.
